(19) United States
(12) Patent Application Publication
(10) Pub. No.: US 2008/0236762 A1
(43) Pub. Date: Oct. 2, 2008

(54) Metering Device and Auxiliary Film Applicator For a Metering Device

(76) Inventors: Waldemar Kiener, Lauchheim (DE); Johann Rein, Bopfingen (DE); Klaus Weng, Bopfingen (DE)

Correspondence Address: KRIEGSMAN & KRIEGSMAN, 30 TURNPIKE ROAD, SUITE 9, SOUTHBOROUGH, MA, 01772, US

(21) Appl. No.: 11/885,134

(22) PCT Filed: Feb. 23, 2006
(86) PCT No.: PCT/EP06/01666

§ 371 Date: Jun. 6, 2008

(30) Foreign Application Priority Data
Feb. 25, 2005 (DE) 10 2005 009 243.8
Feb. 28, 2005 (DE) 10 2005 009 590.9

(51) Int. Cl. B32B 37/12

(52) U.S. Cl. 156/578

(57) ABSTRACT

A metering device which, for the purpose of forming an adhesive medium sump (21), is associated with an application roller (16), having at least one film applicator (36), a pull-off edge (50) of said film applicator (36) extending in a metering gap (28) formed between the application roller (16) and the metering device (14), is characterized in that an adhesive medium dispenser (51) is provided, in the metering gap (28), on a film applicator (36) side situated opposite the adhesive medium sump (21). A metering device as described above is characterized in that the dispenser (51) is aligned so as to lead away from the applicator roller (16).

The invention relates to a metering device and to an auxiliary film applicator for a metering device.

DE 103 54 153 B3 discloses a metering device which is arranged in relation to an application roller in such a way that an adhesive medium sump is formed between the two. For setting the width of the metering gap, the metering device is arranged at a desired distance from (the application roller. The metering device comprises in one region a film applicator, which is associated with the application roller for applying an adhesive medium. This application roller comprises, for example, a multiplicity of punctiform depressions or cells, so that a spot coating of adhesive medium on a substrate web is made possible. The film applicator is set in such a way that the cells are filled with adhesive medium and the surface of the application roller is cleaned. The cohesive force of the adhesive medium has the effect of inducing splitting of the film in the region of the cells. This can lead to small particles of adhesive medium accumulating on the side of the film applicator that is opposite from the adhesive medium sump. These particles combine over time into drops, which can get onto the application device under the effect of gravitational force if they are of a corresponding size. The direction of rotation of the application roller causes these drops to be transferred to the substrate web, so that further adhesive medium is applied outside the spot coating.

The invention is therefore based on the object of providing a metering device and an auxiliary film applicator for a metering device that make it possible to remove accumulating particles of adhesive medium from the film applicator.

This object is achieved according to the invention by a metering device according to the features of claim 1 and an auxiliary film applicator according to the features of claim 12.

Arranging an adhesive medium dispenser in the metering gap on a side of the film applicator that is opposite from the adhesive medium sump makes it possible for particles accumulating on the film applicator to be removed during the cleaning of a surface of the application roller, so that they do not get onto the application roller. This dispenser makes quick and continuous removal of even very small accumulating particles of the adhesive medium possible.

According to an advantageous refinement of the invention, it is provided that the dispenser is directed away from the application roller. This ensures that the particles of adhesive medium that have accumulated until that time in the region of the pull-off edge of the film applicator are removed and discharged freely downward in the metering gap away from the application roller.

According to a further advantageous refinement of the invention, it is provided that the dispenser is provided flush with the pull-off edge of the film applicator. This prevents accumulation of particles of the adhesive medium between the dispenser and the pull-off edge of the film applicator, particles which, as drops, in turn get onto the application roller. At the same time, removal can be made possible and ensured directly at the place where particles of the adhesive medium originate.

The adhesive medium dispenser, which in particular dispenses particles of adhesive media, is formed as a strip and extends completely along the pull-off edge of the film applicator. This allows: reliable removal of the undesired adhesive medium to be made possible over the entire length of the metering gap.

The adhesive medium dispenser is formed as a planar surface area in the region facing the application roller. Simple production and uniform removal of the accumulating particles or drops of adhesive media are made possible as a result.

With preference, the dispenser has a smooth surface facing the application roller, to make easy sliding along of the particles and droplets of adhesive medium possible, in order for them to be removed of their own accord over the dispenser by gravitational force.

As an alternative to the planar form of the dispenser, the dispenser may have a number of: depressions arranged next to one another and directed transversely to the longitudinal extent of the dispenser in the metering gap. Such depressions may be formed as channel-shaped depressions, which increase the accumulation and removal of the particles or drops of the adhesive medium and advantageously extend up to a dripping edge.

According to a preferred refinement, it is provided that an adhesive medium dispenser is formed in one piece with the film applicator. This allows simple assembly and setting of the dispenser in a metering device to be made possible. At the same time, a pull-off edge may be formed on the side of the film applicator that is opposite from the dispenser, in order to make cleaning of the surface of the application roller possible.

According to an alternative refinement of the invention, the dispenser is provided on an auxiliary film applicator. This allows a metering device to be converted to the specific requirement in a simple way, so that cleaning of the surface of the application roller while simultaneously removing particles or drops of the adhesive medium from the application roller is made possible.

The adhesive medium dispenser and the film applicator are advantageously kept together in one region of the metering device. This allows the previous fastening means, in particular a clamping mechanism, to be retained.

The dispenser advantageously has a free dripping edge, which is directed downward in the metering gap. This dripping edge facilitates detachment of the particles or drops of adhesive medium, thereby preventing accumulation of larger drops or amounts of adhesive media. This dripping edge may be formed not only as a straight, horizontally running edge but also as an inclined edge and as a zigzag-shaped, wave-shaped, sawtooth-shaped or rectangular edge or the like. In addition, the edge may have a bevel or a ground surface, in order to facilitate the detachment of the accumulated adhesive medium.

The object is achieved according to the invention by a dispenser for a metering device which has a fastening portion and a film applicator portion, which protrudes into a metering gap and on which a dispenser angled away from the film applicator portion is provided. This auxiliary film applicator makes it possible in a simple way for a film applicator to be supplemented by the removal of particles or drops of the adhesive medium from a pull-off edge of the film applicator that is associated with the application roller. The dispenser, which is formed with preference as a strip-shaped portion, performs the function of a so-called drip nose, without the particles getting onto the application roller.

It is advantageously provided that the dispenser is formed in one piece and is produced from a metal strip. This allows the auxiliary function to be made possible in a low-cost way.

The invention and further advantageous embodiments and developments of the same are described and explained in more detail below on the basis of the examples that are represented in the drawings. The features that can be taken from the description and the drawings can be used according to the invention individually on their own or together in any desired combination. In the drawing:

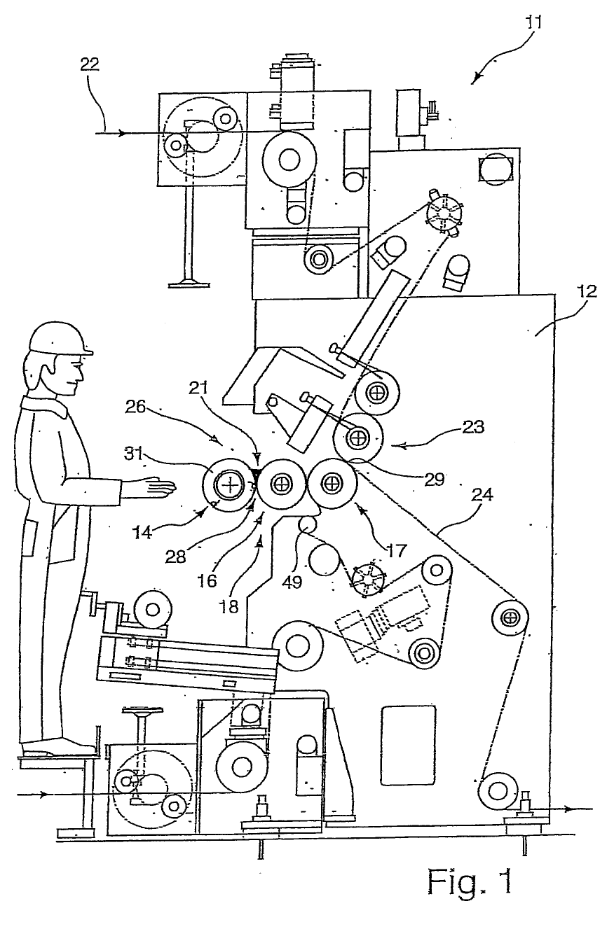

FIG. 1 shows a schematic side view of a multipurpose coating and laminating installation,

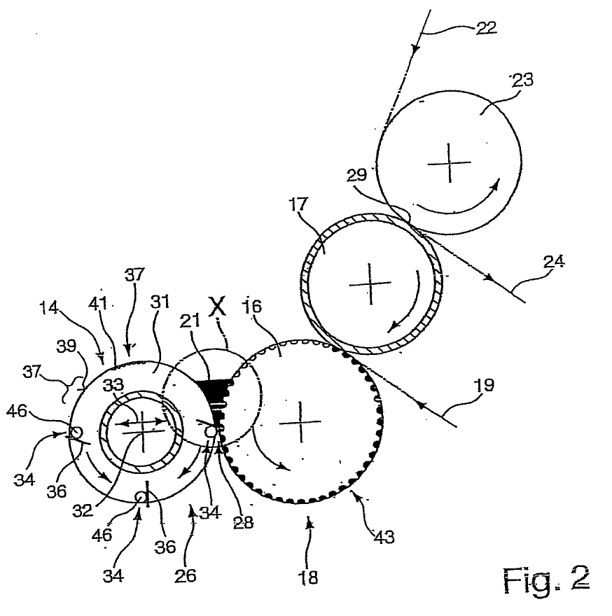

FIG. 2 shows a schematic representation of the device for coating or laminating at least one substrate web and

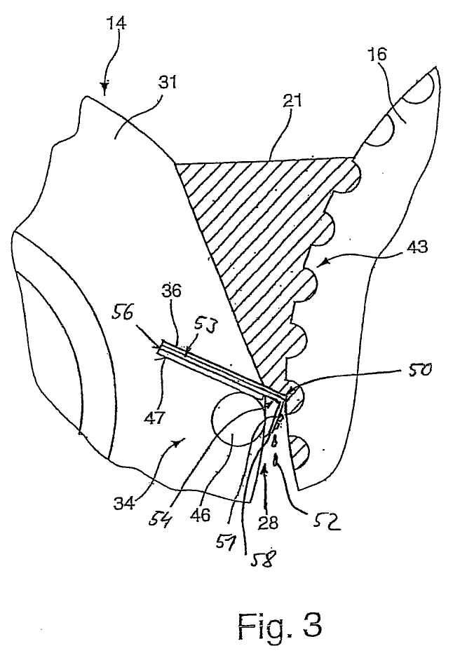

FIG. 3 shows a schematic view of detail X according to FIG. 2.

In FIG. 1, a schematic side view of a coating and laminating installation 11 according to DE 103 54 153 B3 is represented, reference being made to this document in full. Provided on a machine frame 12 are a metering device 14, an application roller 16 and a backing roller or driven roller 17. These form a multiroller system 18, which is used for coating substrate webs 19 with an adhesive medium 21.

In the exemplary embodiment, the substrate web 19 is coated with an adhesive medium 21. Subsequently, a substrate web 22 is fed by means of one or more rollers to a laminating roller 23, which is associated with the backing roller 17, so that the substrate web 22 is laminated onto the substrate web 19 provided with adhesive medium 21. This formed laminate 24 is led out from the coating and laminating installation 11 for further processing or storage. The formed laminate 24 may comprise two or more substrate webs or coatings.

In FIG. 2, a schematic representation of a device 26 according to the invention and the metering device 14 according to the invention are represented. The metering device 14 is arranged, for example, on the same plane as the application roller 16. Formed between the metering device 14 and the application roller 16 is a metering gap 28, via which adhesive medium 21 is applied to the application roller 16. The adhesive medium 21 is stored above the metering gap 28. After the application of the adhesive medium 21 to the application roller 16, the adhesive medium 21 is applied to one side of the substrate web 19. Formed for this between the application roller 16 and the backing roller 17 is a gap, to which the substrate web 19 is fed. If only one coating is intended, the coated substrate web 19 can be removed for further processing or storage. In the present exemplary embodiment, the substrate web 19 with its outer side coated with adhesive medium 21 is deflected by 180° at the backing roller 17 and the substrate web 22 is fed in, so that the laminate 24 is formed at a laminating point 29.

During a coating or laminating operation, the metering device 14 is at a standstill. The application roller 16, backing roller 17 and laminating roller 23 are turned according to the direction of the arrow. These rollers may be self-driven or driven.

The term substrate web is to be understood in the broad sense and comprises woven and knitted fabrics and materials, looped fabrics, non-woven materials, breathable materials, other textiles, foam structures, fibre fabrics, nonwoven fabrics or the like. It may be just a single-layered material, but also a multilayered composite material or an already produced laminate that is bonded with one or more further substrate webs to form a new laminate.

Various types of adhesive media 21 are used in such coating and laminating installations 11. They are usually thermoplastic adhesive media, which have the property of entering into a bond with further materials above a softening or melting point. Furthermore, so-called cold-setting adhesive media 21 may be provided. The adhesive media may likewise be of high or low viscosity.

To produce an adhesive medium coating or a laminate, furthermore, different application structures of the adhesive medium 21 are also desired. For the application of different application structures, the metering device 14 and/or the application roller 16 may have corresponding structures and surfaces. The metering device 14 at least partially comprises a body 31 in roller form that is rotatably mounted about a longitudinal axis 32. Furthermore, the longitudinal axis 32 is arranged displaceably along the arrow 33, it being possible for the rotation and the displaceability to coincide. The displaceability according to arrow 33 has the effect that the width of the metering gap 28 is preset or set. The rotation of the body 31 of the metering device 14 has the effect of setting the metering device 14 to different application structures. Provided in a first region 34 of the metering device 14 is a film applicator 36, which according to the exemplary embodiment is associated with the metering gap 28. Furthermore, the metering device 14 has two further film applicators 36 and also two further regions 37, which are formed on a peripheral wall or a peripheral wall portion 38 of the body 31. The further regions 37 comprise a smooth surface structure 39 and also a structured surface 41. The metering device 14 is formed by way of example as a body 31 in roller form. Other forms of body that have at least a first region 34 and at least a further region 37 are likewise possible as the body 31.

According to FIG. 2, the application roller 16 has, for example, a punctiform structure 43, which takes up the adhesive medium 21 and transfers it to the substrate web 19.

The metering gap 28 is shown enlarged in FIG. 3, like the arrangement of the film applicator 36, according to detail X in FIG. 2. The film applicator 36 is fastened by a quickly releasable fastening means 46, preferably an eccentric tensioner. This releasable fastening means 46 allows the film applicator to enter to a greater or lesser extent to a gap 47, and consequently to be set to a corresponding metering width. In this positive position, the film applicator 36 has a stripping function. The adhesive medium 21 is introduced into the structure 43′ of the application roller 16, the adjacent peripheral surface being kept free of adhesive medium 21. Consequently, an open-pore or air-permeable coating structure can be applied to the substrate web 19. With preference, the rotational speed of the backing roller 17 is set to synchronize with the application roller 16, so that the coating of the substrate web 19 substantially covers the structure 43 of the application roller 16.

The wheel setting represented in FIG. 3 is used with preference for thermoplastic adhesives and PU (polyurethane) adhesives, which can be both of high and low viscosity.

The structure 34 of the application roller 16 that is filled with adhesive medium and is formed for example by the cells is made to pass by a pull-off edge 50 of the film applicator 36. As this happens, the surface of the application roller 16 is cleaned and the full cells are skimmed over. This allows a spot coating to be applied to a substrate web 19. During the passing over of the cells in the application roller 16, the cohesive force of the adhesive medium causes a splitting of the film to follow, whereby particles 52 of the adhesive medium accumulate at or near the pull-off edge of the film applicator 36. In order that these particles 52 of the adhesive medium can be removed, a dispenser 51 is provided. This dispenser 51 is directed downward in the metering gap 28, opposite from the adhesive medium sump 21. At the same time, a free end of the dispenser 51 is provided such that it points or is inclined away from the application roller 16, so that the particles 52 of the adhesive medium can be removed freely downward in the metering gap 28.

According to FIG. 3, the dispenser 51 is formed as one part and is provided on an auxiliary film applicator 56. The latter comprises a fastening portion 53, which is intended with preference to be received in a clamping manner together with the film applicator 36 in the metering device 14. The fastening portion 53 is adjoined by a film applicator portion 54, which according to the embodiment in FIG. 3 supports the film applicator 36 protruding into the metering gap 28 or lies against the underside of the film applicator 36. Provided at the end of the film applicator portion 54 is the dispenser 51, angled away from the film applicator portion 54.

The dispenser 51 has a planar surface area, which is directed toward the application roller 16. For simple production of the auxiliary film applicator 56, material in strip form, preferably a metal strip, is folded or profiled, so that for example an L shape or a shape approximating that is formed. The dispenser 51 may be formed as a straight leg. Alternatively, the dispenser 51 may have a curved surface area, so that a slight gradient is provided directly adjoining the pull-off edge 50 of the film applicator 36, in order to remove the particles 52 quickly from the application roller 16, and toward the end of the dispenser 51 there is a large gradient, which goes over virtually into a perpendicular arrangement, in order to facilitate the detachment of the particles 52 of the adhesive medium.

Seen along the metering gap 28, the dispenser 51 is formed as a strip. A dripping edge 58 at the lower end of the dispenser 51 is formed continuously and, with preference, running parallel to the pull-off edge 50 of the film applicator 36. Alternatively, the dripping edge 58 may have a toothed, wavy, rectangular, wave-shaped or continuously rising and/or falling edge profile.

As an alternative to the embodiment represented in FIG. 3, it is provided that the dispenser 51 is adhesively attached, fitted, welded, riveted, soldered, crimped or fastened in a similarly: releasable manner to an underside of a film applicator 36. Similarly, the film applicator 36 and the auxiliary film applicator 56 may be formed as one part.

In the case of the embodiment represented in FIG. 3, it may additionally be provided that the film applicator 36 has on its side opposite from the pull-off edge 50 a shoulder or an overhang that is adjoined by the auxiliary film applicator 56. This shoulder has a slope, which is formed such that it faces directly away from the application roller 16. A gap forming between the film applicator 36 and the auxiliary film applicator 56 is thereby additionally closed. At the same time, an assembly aid for positioning the auxiliary film applicator 56 with respect to the film applicator 36 is obtained.

The features described above can be combined with one another in any desired way and are each in themselves essential for the invention.

1. A metering device which, to form an adhesive medium sump, is associated with an application roller, with at least one film applicator, which extends with a pull-off edge in a metering gap formed between the application roller and the metering device, characterized in that an adhesive medium dispenser is provided in the metering gap on a side of the film applicator that is opposite from the adhesive medium sump.

2. The metering device as claimed in claim 1, characterized in that the dispenser is directed away from the application roller.

3. The metering device as claimed in claim 1, characterized in that the dispenser is provided flush with the pull-off edge of the film applicator.

4. The metering device as claimed in claim 1, characterized in that the dispenser is formed as a strip and extends completely along the pull-off edge of the film applicator.

5. The metering device as claimed in claim 1, characterized in that the dispenser has a planar surface area facing the application roller.

6. The metering device as claimed in claim 1, characterized in that the dispenser has a smooth surface facing the application roller.

7. The metering device as claimed in claim 1, characterized in that the dispenser has a number of depressions arranged next to one another, extending up to a dripping edge and directed transversely to the longitudinal extent of the dispenser.

8. The metering device as claimed in claim 1, characterized in that the dispenser is provided in one piece with the film applicator.

9. The metering device as claimed in claim 1, characterized in that the dispenser is arranged on an auxiliary film applicator.

10. The metering device as claimed in claim 1, characterized in that the dispenser and the film applicator are fastened together in one region.

11. The metering device as claimed in claim 1, characterized in that the dispenser has a free dripping edge, which is directed downward in the metering gap.

12. An auxiliary film applicator for a metering device as claimed in claim 1, with a fastening portion and a film applicator portion, which protrudes into a metering gap and on which a dispenser angled away from the film applicator portion is arranged.

13. The auxiliary film applicator as claimed in claim 12, characterized in that the dispenser is produced by folding toward the film applicator portion or from a profiled material in strip form.

14. The auxiliary film applicator as claimed in claim 13, characterized in that the material in strip form is produced from a metal strip or metal sheet.
